(19) United States
(12) Patent Application Publication
(10) Pub. No.: US 2015/0023303 A1
(43) Pub. Date: Jan. 22, 2015

(54) INTERWORKING BETWEEN SYSTEMS USING DIFFERENT IP MOBILITY MANAGEMENT PROTOCOLS

(71) Applicant: Zu QIANG, Kirkland (CA)

(72) Inventor: Zu QIANG, Kirkland (CA)

(73) Assignee: TELEFONAKTIEBOLAGET L M ERICSSON (PUBL), Stockholm (SE)

(21) Appl. No.: 14/507,673

(22) Filed: Oct. 6, 2014

Related U.S. Application Data
(63) Continuation of application No. 13/025,371, filed on Feb. 11, 2011.
(60) Provisional application No. 61/303,457, filed on Feb. 11, 2010.

(51) Int. Cl. H04W 76/02; H04W 12/06; H04W 88/16; H04W 60/00; H04W 80/04

(52) U.S. Cl. CPC H04W 76/02; H04W 60/00; H04W 80/04; H04W 88/16; H04W 12/06
USPC 370/329

(57) ABSTRACT

Systems and methods allow 3GPP and non-3GPP access with interworking between GTP-based networks and PMIP-based networks. For handover attachment of a UE, an IWP can be provided the address of the PGW which was used in the initial attachment of the UE so that, for example, an IP address can be maintained for an ongoing data connection established with the UE. Alternatively, the same IWP can operate as the proxy for all data connections with the UE such that the IWP is aware of the PGW used for the initial attachment and can reuse the same PGW for handover.

### RELATED APPLICATIONS

This application is related to, and claims priority from, U.S. Provisional Patent Application No. 61/303,457, filed on Feb. 11, 2010, and U.S. Provisional Patent Application No. 61/306,041, filed on Feb. 19, 2010, the disclosures of which are incorporated here by reference.

### TECHNICAL FIELD

This application relates generally to 3GPP access and, more particularly, to interworking between radiocommunication systems.

### BACKGROUND

During the past years, the interest in using mobile and landline/wireline computing devices in day-to-day communications has increased. Desktop computers, workstations, and other wireline computers currently allow users to communicate, for example, via e-mail, video conferencing, and instant messaging (IM). Mobile devices, for example, mobile telephones, handheld computers, personal digital assistants (PDAs), etc., also allow users to communicate via e-mail, video conferencing, IM, and the like. Mobile telephones have conventionally served as voice communication devices, but through technological advancements they have recently proved to be effective devices for communicating data, graphics, etc. As user demand for seamless communications across different platforms increases, which in turn creates more usage and leads to more services and system improvements, it is expected that wireless and landline technologies will continue to merge into a more unified communication system in support of such demand.

Various systems and methods have been used to deliver and/or request information between devices, nodes and networks in support of customer demand. In particular, the demand for data or IP connections continues to rapidly escalate. For example, with the rapidly growing popularity of the Internet on fixed and mobile networks, many networking systems often need to process more data, offer more bandwidth and to quickly introduce more features to the system while minimizing any negative impact on the currently existing capabilities of the systems themselves. Among many other techniques of interest, mobility between networks which offer data connections, e.g., IP connections, is highly desirable.

The Third Generation Partnership Project (3GPP) is pursuing enhancement of the Proxy Mobile IP-GPRS Tunneling Protocol (PMIP-GTP) proxy Procedures. PMIP is a network-based mobility management protocol for IP connections standardized by IETF used by, for example 3GPP-based radiocommunication systems. GTP is a related protocol used in, for example, GSM and WCDMA systems for mobility management associated with IP connections. It is anticipated that there will be some radiocommunication systems which employ PMIP and other radiocommunication systems which employ GTP for IP connection mobility. Thus, the PMIP-GTP proxy Procedures specified in various 3GPP standards documents (identified below) provide techniques for PMIP-based Public Land Mobile Network (PLMN) interworking with a GTP-based PLMN when, for example, such networks are located adjacent to one another as shown in the conventional FIG. 1. Therein a first network 100 uses GTP for its IP connection mobility protocol and a second network 102 uses PMIP for its IP connection mobility protocol. If a user equipment (UE) 104 moves, for example, from network 100 to network 102 while it has an ongoing IP connection, it would be desirable to seamlessly maintain that connection despite the fact that the two networks use different IP mobility protocols.

Some of the conventional nodes of interest in the first network 100 and second network 102 are shown in FIG. 2. These nodes include a Serving Gateway (SGW) 200 which is the gateway which terminates the interface towards E-UTRAN, the PDN Gateway (PGW) 202 which is the gateway which terminates the UE IP session towards the packet data network (PDN), the Interworking Proxy (IWP) 204 which is the gateway between a GTP-based visit network and a PMIP-based home network, or a PMIP-based visit network and a GTP-based home network. The IWP 204 proxies the PMIP signaling with the GTP signaling and it also forwards the UE payload packets between the GTP tunnel and the PMIP tunnel. The non-3GPP Access Gateway (AGW) 206 handles access to the 3GPP network from non-3GPP networks. The Mobility Management Entity (MME) 208 performs various functions including UE mobility management, Authentication, Authorization, Roaming, PDN GW and Serving GW selection, etc. The Home Subscriber Server (HSS) 210 stores various information about subscribers and their UEs, and the 3GPP AAA proxy server 212 and 3GPP AAA server 214 provide various authentication and authorization functions associated with network accesses.

It will be appreciated that the interworking scenarios discussed herein can operate in either direction, i.e., the left hand side of FIG. 2 can represent either a PMIP-based visited network or a GTP-based visited network and the right hand side of FIG. 2 can then represent the other type of network, i.e., either a GTP-based home network or a PMIP-based home network, respectively. Thus, the reference numbering scheme shown in FIG. 2 is re-used herein for similar nodes which may reside either in a PMIP-based network or a GTP-based network. For a 3GPP access, there are two interworking scenarios of interest: a PMIP based Serving Gateway (SGW) 200 in the visited network can communicate with a GTP based Packet Data Network Gateway (PGW) 202 in the home network via an interworking proxy function (IWP) 204; or a GTP based SGW 200 in the visited network can communicate with a PMIP based PGW 202 in the home network via the IWP 204. For a non-3GPP access, there is one scenario of interest wherein the non-3GPP access gateway may be connected to the home PLMN via chained SGW and via the interworking proxy function (IWP) 204.

As specified in the standards document 3GPP TS 23.401, the PGW selection is performed by the Mobility Management Entity (MME) 208 for the first attachment. Alternately, PGW selection can be performed by the Home Subscriber Server (HSS) 210 during authentication procedure if the PGW info was stored from previous attachment. After attachment, the MME 208 shall update the selected PGW info towards the HSS 210.

As specified in the standards document 3GPP TS 29.875, the IWP address is statically configured as PGW address in the DNS for a particular access point node (APN). During an authentication procedure, the IWP address is sent to the MME 208 as the PGW address. Then the IWP 204 has to resolve the PGW address based on the APN received from SGW 200. If there is stored PGW address info in the HSS 210 due to a previous attachment or static configuration, the PGW info cannot be delivered to the IWP 204.

For the non-3GPP access scenario, as specified in 3GPP TS 23.402, the PGW selection is performed by the non-3GPP access GW 206 for the first attachment, or by the HSS/AAA 210, 214 during an authentication procedure if the PGW info was stored from a previous attachment. For the chained case, both the SGW address and the PGW address may be sent to the non-3GPP access GW 206 during the authentication procedure. After attachment, the PGW 202 updates the stored PGW info in the HSS/AAA 210, 214 over an S6b interface. The operation of the 3GPP AAA proxy server 212 and the 3GPP AAA server 214 are further described below. These scenarios pose various difficulties with respect to the 3GPP access cases, specifically with respect to the selection of a PGW 202 as part of the interworking process.

To illustrate these difficulties associated with using existing PMIP-GTP interworking functionality, e.g., as described in the standards documents 3GPP TS 23.401, 23.402 and 29.875, exemplary conventional signaling associated with such interworking is illustrated in FIG. 3. Therein, at step 300, the SGW selection is performed by the 3GPP AAA Proxy server 212. Then the SGW address is provided by the 3GPP AAA Proxy server 212 to the non-3GPP access GW 206. The IWP 204's address is also provided by the 3GPP AAA Proxy server 212 to the non-3GPP access GW 206 as a PGW identity.

In step/signal 302, the IWP address is sent over the proxy binding update (PBU) as a PGW identity to the SGW 208. Then the SGW 208 uses IWP address as an LMA address for the PBU signal 304. Since the IWP 204 does not have any PGW information, the IWP has to perform the selection of which PGW 202 to use for the interworking After the PGW 202 is selected, the IWP 204 sends a Create Session Request message 306 to the selected PGW 202.

In step/signal 308, after the payload tunnel is created, the PGW 202 shall behave as set forth in 3GPP TS 23.401 and 3GPP TS 23.402 to update the 3GPP AAA server 214 with its identity. The 3GPP AAA server 214 then conveys this information to the HSS 210 for the UE whose connection is being moved to the visited network. Once the GTP session is created between the PGW 202 and the IWP 204, a GTP response message 310 is returned to IWP 204 which will trigger a PMIP response message 312, shown as a proxy binding acknowledgement (PBA) to be sent back to SGW 208 and then on to the non-3GPP access GW 206 via PBA 314, by which process a PMIP tunnel is created between the IWP 204 and the non-3GPP access GW 206.

The interworking process shown in FIG. 3 has certain drawbacks. For example, since the IWP 204 performs the PGW selection in order to determine where to send the Create Session Request message 306, it will be appreciated by those skilled in the art that the session may not be terminated at the current PGW 202 under certain circumstances. This failure to terminate the session will negatively impact some packet data services. Furthermore, as shown in step/signal 308, the PGW 202 updating its identity toward the HSS/AAA 210, 214 will have the effect of overwriting the IWP address info which shall be provided to the non-3GPP access GW 206 at step 300. This can render the overall procedure nonfunctional if the UE involved in this interworking attaches to the non-3GPP access GW 206 again or if the UE initiates additional PDN connections.

It may be possible to omit step/signal 308 in order to avoid this problem. However, when this is done, the IWP 204 may have to perform PGW selection each time. In other words, there is no guarantee that the UE will connect to the same PGW 202 on successive attempts, which may also negatively impact some packet data or IP services.

Therefore, it would be desirable to provide a system and method that obviate or mitigate the above described problems.

### SUMMARY

Systems and methods allow 3GPP and non-3GPP access with interworking between GTP-based networks and PMIP-based networks. For handover attachment of a UE, an IWP can be provided the address of the PGW which was used in the initial attachment of the UE so that, for example, an IP address can be maintained for an ongoing data connection established with the UE. Alternatively, the same IWP can operate as the proxy for all data connections with the UE such that the IWP is aware of the PGW used for the initial attachment and can reuse the same PGW for handover.

According to an embodiment, a method for interworking between a Proxy Mobile IP (PMIP)-based network and a GPRS Tunneling Protocol (GTP)-based network includes the steps of performing, by an interworking proxy function (IWP), an initial attach process for a user equipment's connection to a visited one of the PMIP-based network and the GTP-based network including selection, by the IWP, of a packet gateway (PGW) in a home other of the PMIP-based network and the GTP-based network, and performing, by the IWP, a handover attach process associated with the user equipment in the visited one of the PMIP-based network and the GTP-based network using the same PGW by maintaining and re-using a connection established between the IWP and the PGW during the initial attach process.

According to another embodiment, an interworking proxy function (IWP) node for performing interworking between a Proxy Mobile IP (PMIP)-based network and a GPRS Tunneling Protocol (GTP)-based network includes a processor configured to perform functions associated with an initial attach process for a user equipment's connection to a visited one of the PMIP-based network and the GTP-based network including selection of a packet gateway (PGW) in a home other of the PMIP-based network and the GTP-based network, and further configured to perform functions associated with a handover attach process for the user equipment in the visited one of the PMIP-based network and the GTP-based network using the same PGW by maintaining and re-using a connection established between the IWP and the PGW during the initial attach process.

According to another embodiment, a method for interworking between a Proxy Mobile IP (PMIP)-based network and a GPRS Tunneling Protocol (GTP)-based network includes the steps of performing, by an interworking proxy function (IWP), a handover attach process associated with the user equipment operating in a visited one of the PMIP-based network and the GTP-based network using a same PGW in the home other of the PMIP-based network and the GTP-based network as was used for an initial attach process for the user equipment by receiving, at the IWP, an address associated with the PGW via an external signal.

According to another embodiment, an interworking proxy function (IWP) node for performing interworking between a Proxy Mobile IP (PMIP)-based network and a GPRS Tunneling Protocol (GTP)-based network includes a processor configured to perform functions associated with a handover attach process for the user equipment in a visited one of the PMIP-based network and the GTP-based network using a same PGW as used for an initial attach process for the user equipment by receiving, at the IWP, an address associated with the PGW via an external signal.

### ABBREVIATIONS/ACRONYMS

3GPP Third Generation Partnership Project

AAA Authentication, Authorization, and Accounting

APN Access Point Node

DNS Domain Name Server

GSM Global System for Mobile communications

GTP GPRS Tunneling Protocol

GW Gateway

hPLMN Home Public Land Mobile Network

HSS Home Subscriber Server

IWP Interworking Proxy Function

MME Mobility Management Entity

PDN Packet Data Network

PGW Packet Gateway

PLMN Public Land Mobile Network

PMIP Proxy Mobile IP

SGW Serving Gateway

TS Technical Specification

WCDMA Wideband Code Division Multiple Access

UE User Equipment

vPLMN Visited Public Land Mobile Network

### BRIEF DESCRIPTION OF THE DRAWINGS

Embodiments of the present invention will now be described, by way of example only, with reference to the attached Figures, wherein:

FIG. 1 depicts a conventional GTP-based PLMN adjacent to a conventional PMIP-based PLMN;

FIG. 2 illustrates a conventional architecture associated with adjacent networks connected via an interworking proxy function;

FIG. 3 is a signaling diagram showing interworking according to a conventional procedure;

FIG. 4 is a signaling diagram illustrating interworking according to a first embodiment;

FIG. 5 is a signaling diagram illustrating interworking according to a second embodiment;

FIG. 6 depicts a modification to the architecture of FIG. 2 in support of the embodiment of FIG. 5;

FIGS. 7 and 8 illustrate architectures associated with a third embodiment in which all data connections are routed through the interworking proxy function;

FIG. 9 is a signaling diagram illustrating interworking according to the third embodiment;

FIG. 10 illustrates an exemplary interworking proxy function (IWP) node according to an embodiment; and

FIGS. 11 and 12 are flowcharts illustrating methods for interworking according to embodiments.

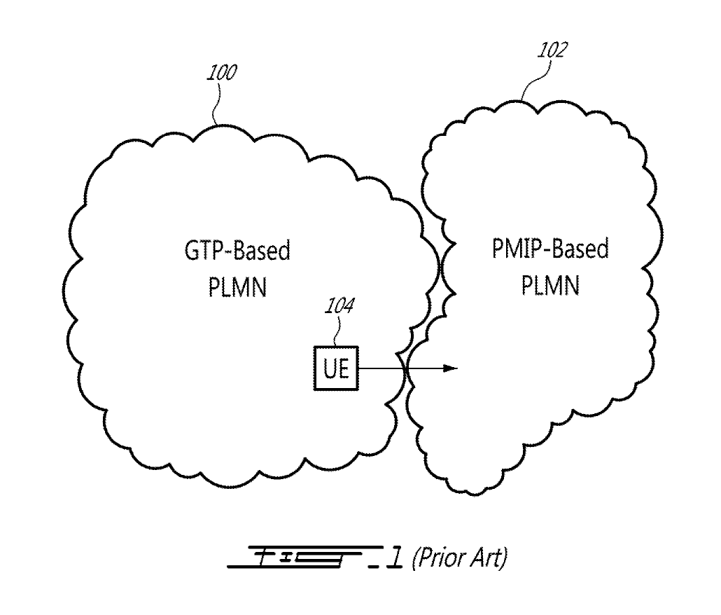

### DETAILED DESCRIPTION

The present invention is directed to a system and method for connecting to nodes in a 3GGP network.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by, among other things, replacing elements with equivalent functional elements.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

In the following discussion, embodiments of the present invention will be presented that provide a mechanism to obviate or mitigate the problems outlined above through the use of an additional parameter or an additional interface in the interworking architecture. Moreover, it will be appreciated by those skilled in the art that although embodiments described herein are discussed in terms of mobility in one direction, i.e., wherein the GTP-based network is a visited PLMN for a particular UE which has, as its home PLMN, a PMIP-based network, that these embodiments apply equally to mobility in the other direction, i.e., from a GTP-based home network to a PMIP-based visited network.

In a first embodiment, both the IWP address and the PGW address associated with a particular UE's IP connection mobility are saved by storing these addresses in the 3GPP AAA server 214. The 3GPP AAA server 214 is thus able to provide the PGW address for a UE's current data connection to the IWP 204 as part of a handover attach process, so that the UE can continue its data connection through the same PGW 202 and maintain the same IP address for that ongoing data connection.

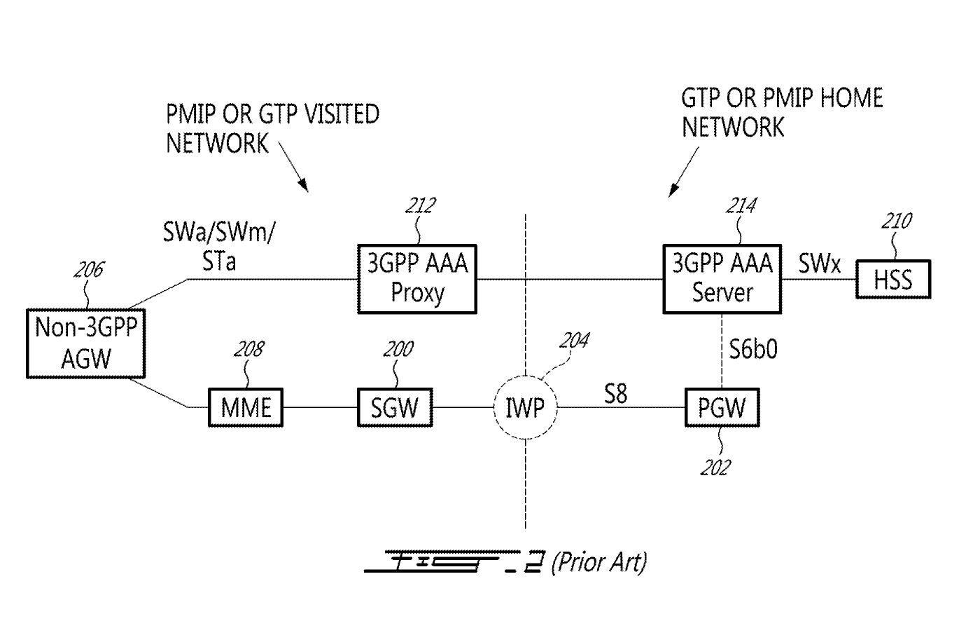

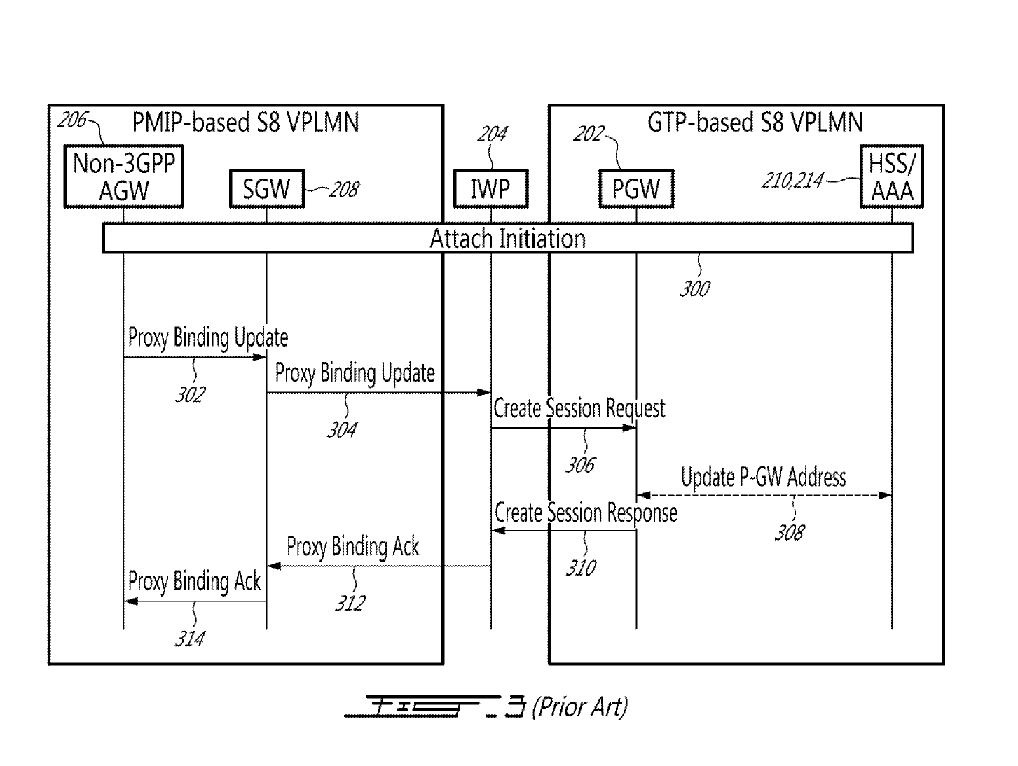

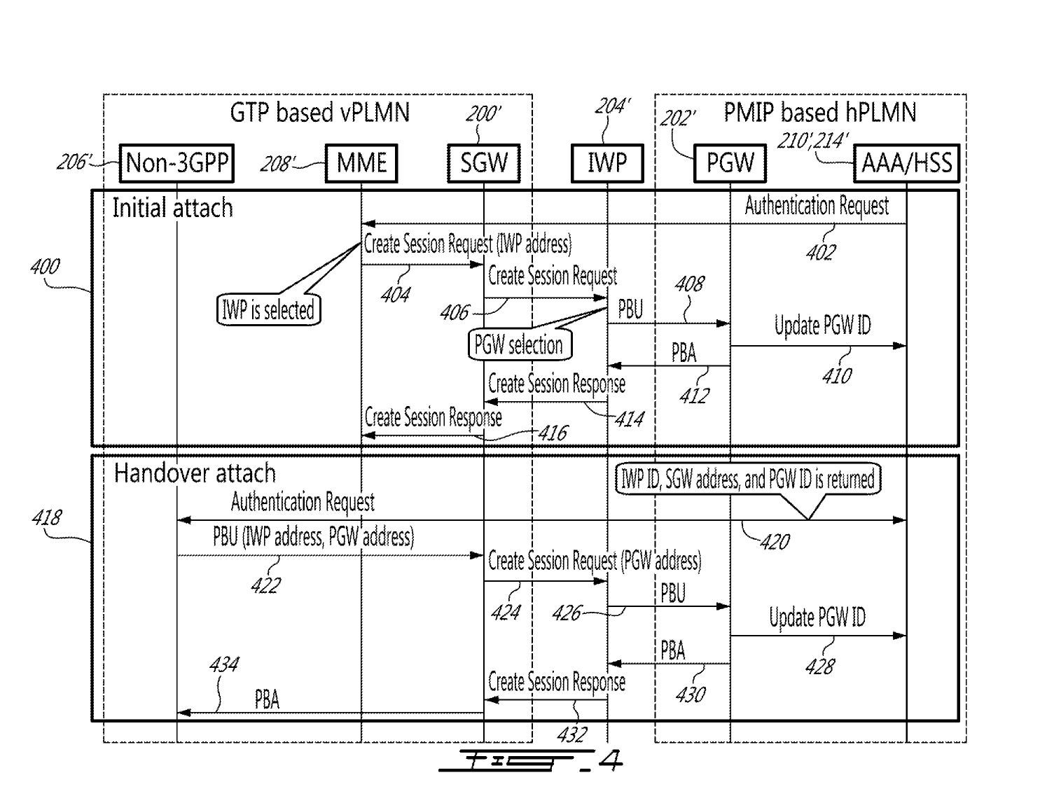

An example of signaling associated with this first embodiment is provided as FIG. 4, which again uses the node reference numbering described above with respect to FIG. 2 except with an added prime symbol to indicate that these nodes operate in accordance with one or more of the embodiments. Therein, during the initial attachment process 400 which occurs, e.g., when the UE 104 is powered on while roaming in the GTP-based visited network, the 3GPP AAA server 214′ authenticates the UE 104 and provides authentication information to the MME 208′ via signaling 402. The MME 208′ selects an IWP 204′ to use for interworking purposes and uses this information to generate and transmit a Create Session Request signal 404 toward the SGW 200′, the signal 404 including the IWP address for the IWP 204′.

Upon receipt, the SGW 200′ transmits a corresponding Create Session Request signal 406 toward IWP 204′ using the IWP address which it received from the MME 208′. In this embodiment, the IWP 204′ selects the PGW 202′ to use for the interworking and transmits a Proxy Binding Update (PBU) toward that PGW 202′ to setup a PMIP tunnel with the home network for UE 104's roaming IP connection. The PGW 202′ updates the 3GPP AAA server 214′ via signal 410, which signal includes its PGW address, the address of SGW 200′ and the address of the IWP 204′ which sent signal PBU 408. The 3GPP AAA server 214′ stores the PGW address, the SGW address and the IWP address received via signal 410 associated with this UE 104's roaming IP connection for potential later re-use during a handover attachment process associated with the same UE 104 as described below.

The PGW 202′ returns a Proxy Binding Acknowledgement (PBA) signal 412 to the IWP 204′, which in turn transmits a Create Session Response signal 414 to the SGW 200. The SGW 200′ returns a Create Session Response signal 416 to the MME 208, which completes the Initial Attach process for UE 104.

Now that the addresses for the SGW 200, IWP 204′ and PGW 202′ are stored in the 3GPP AAA server 214′ in the PMIP-based home network, they can be reused for subsequent attachment procedures associated with the same UE. For example, if UE 104 moves into another, non-3GPP cell in the GTP-based visited network, these stored addresses can be reused as shown in the handover attachment signaling 418 illustrated in the lower half of FIG. 4.

Therein, at signal/step 420, when the authentication request for UE 104 transmitted by the non-3GPP GW 206′ in the GTP-based visited network is received by the 3GPP AAA server 214′, the 3GPP AAA server 214′ can retrieve the previously stored addresses. More specifically, as shown in FIG. 4, the 3GPP AAA server 214′ can send the addresses of the IWP 204′, SGW 200′ and PGW 202′ which were previously used by UE 104 to support its packet data connection to the non-3GPP GW 206′ in signal 420. According to one embodiment, the addresses can be conveyed to the non-3GPP GW 206 by the 3GPP AAA proxy server 212′ using an additional parameter on a DIAMETER interface between the 3GPP AAA proxy server 212′ and the non-3GPP GW 206. These addresses can then be used for the rest of the handover attachment process. For example, the non-3GPP GW 206′ can generate and transmit a PBU signal 422 including the IWP address and PGW address which it received from the 3GPP AAA server 214′ toward the SGW 200′ whose address it also received during the authentication procedure 420.

The SGW 200′ can, in turn, generate and transmit a Create Session Request signal 424 toward the IWP 204′ whose address it received in the PBU signal 422, the Create Session Request signal 424 including the address of the PGW 202′ to be used for this interworking process, which PGW address was also included in the PBU signal 422′. The IWP 204′ generates and transmits its own PBU signal 426 toward the PGW 202′ which it was instructed to use. Thus, in this embodiment, the IWP 204′ is not responsible for PGW selection. The PGW 204′ updates the HSS/3GPP AAA server 210′, 214′ in the normal manner via signal 428 and the session setup is completed via signals 430-434 in the same manner as described above.

Note that although this re-use of stored PGW, IWP and SWP addresses for interworking purposes has been described with respect to handover attachment 418, the process illustrated in FIG. 4 can be used for any subsequent data connection to be established for a roaming UE in a GTP-based or PMIP-based network whose home network is a PMIP-based or GTP-based network, respectively, and for which a set of addresses is already stored in its home 3GPP AAA server 214′ or HSS 210′.

According to a second embodiment, instead of having a stored PGW address forwarded to the IWP 204′ as part of the Create Session Request signal, e.g., a push embodiment, the IWP 204′ can retrieve the stored PGW address for use in the interworking process, e.g., a pull embodiment. This second embodiment also enables the same PGW 202′ to be used for a data connection which is being handed over despite the different IP mobility protocols which are involved in the visited and home systems.

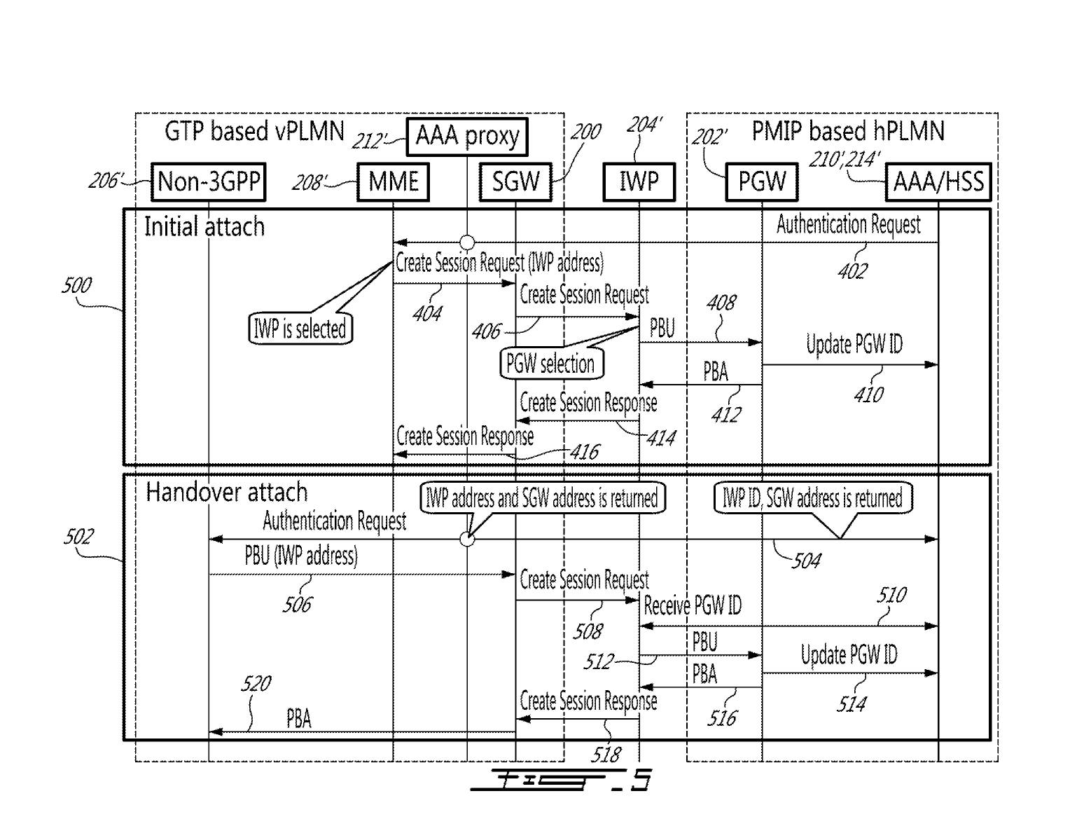

An example of signaling associated with this embodiment is illustrated in FIG. 5. Therein, the initial attachment process 500 for a UE 104, e.g., which is powered on while roaming in a GTP-based visited network, is the same as the initial attach process 400 described above with respect to the embodiment of FIG. 4. Accordingly, the same reference numerals are used in FIG. 5 for this portion of the figure and reference is made to the previous description of this signaling which is not repeated here.

However, for a subsequent handover attachment 502 of the same UE 104, the signaling and process according to this second embodiment is somewhat different than that of the first embodiment. For example during the authentication process 504, the 3GPP AAA server 214′ of the PMIP-based home network retrieves and forwards the previously stored SGW and IWP addresses associated with the UE 104 being authenticated for handover, but not the PGW address. The non-3GPP GW 206′ uses the received SGW address to generate and send PBU 506, which includes the IWP address which it received from the home network. The SGW 200′ uses the received IWP address to generate and send a Create Session Request message 508 toward the identified IWP 204′.

Instead of selecting a PGW 202′ on its own, the IWP 204′ according to this embodiment retrieves the address of the PGW to be used for this interworking for this particular UE 104 from 3GPP AAA server 214′ via signaling 510 (which involves a request and a response signal which are shown as a single arrow 510). The 3GPP AAA server 214′ retrieves the PGW address for UE 104, which was previously stored during the initial attach procedure 500, and returns the PGW address to the IWP 204′. The IWP 204′ uses the received PGW address to generate and send a PBU message 512 toward PGW 202′ to establish the PMIP session for this roaming IP access. The PGW 202′ updates the HSS/3GPP AAA server 210′, 214′ in the normal manner via signal 514 and the session setup is completed via signals 516-520 in the same manner as described above.

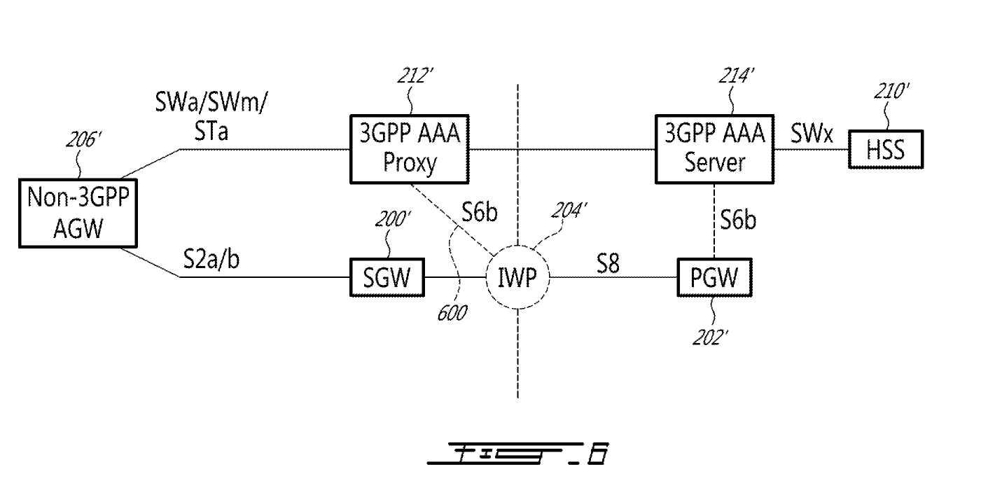

In order to enable the IWP 204′ to retrieve the PGW address from the 3GPP AAA server 214′, a new interface 600, e.g., an S6b interface or reference point, can be provided as shown in FIG. 6 between the IWP 204′ and the 3GPP AAA Proxy server 212′ in the visited network. Thus the signaling 510 shown in FIG. 5 can be implemented via the proxy server 212′.

The first and second embodiments described above depict non-3GPP handover attachment scenarios, however these two embodiments can also be used for the corresponding 3GPP access cases. During authentication, the 3GPP AAA server 214′ can send a statically configured IWP address and the stored PGW address to the MME 208′. The extra IWP address information according to the first embodiment can be provided by using the aforementioned additional parameter at a Diameter interface and a PMIP interface to push that information to IWP 204′. Alternatively, according to the second embodiment, the IWP 204′ can pull (retrieve) the PGW address from the 3GPP AAA server 214′ via the new S6b like network reference point and 3GPP proxy server 212′.

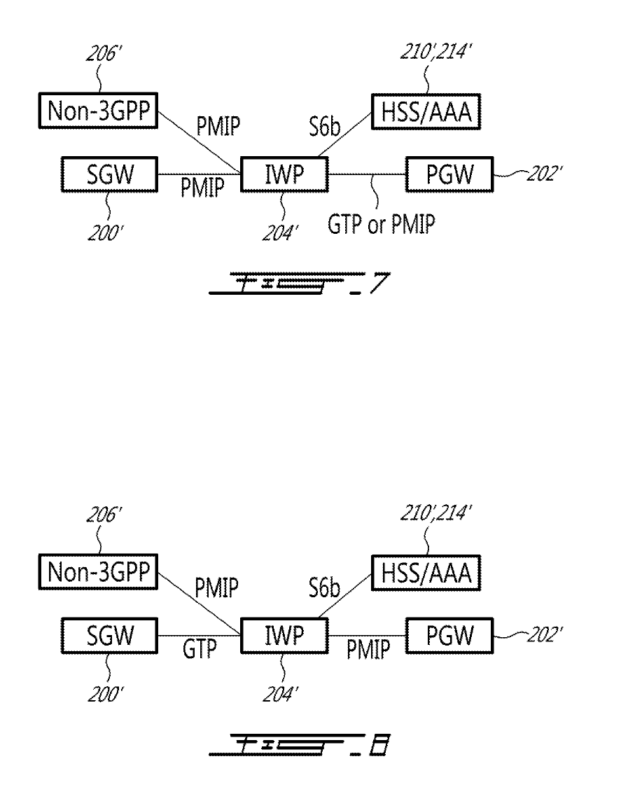

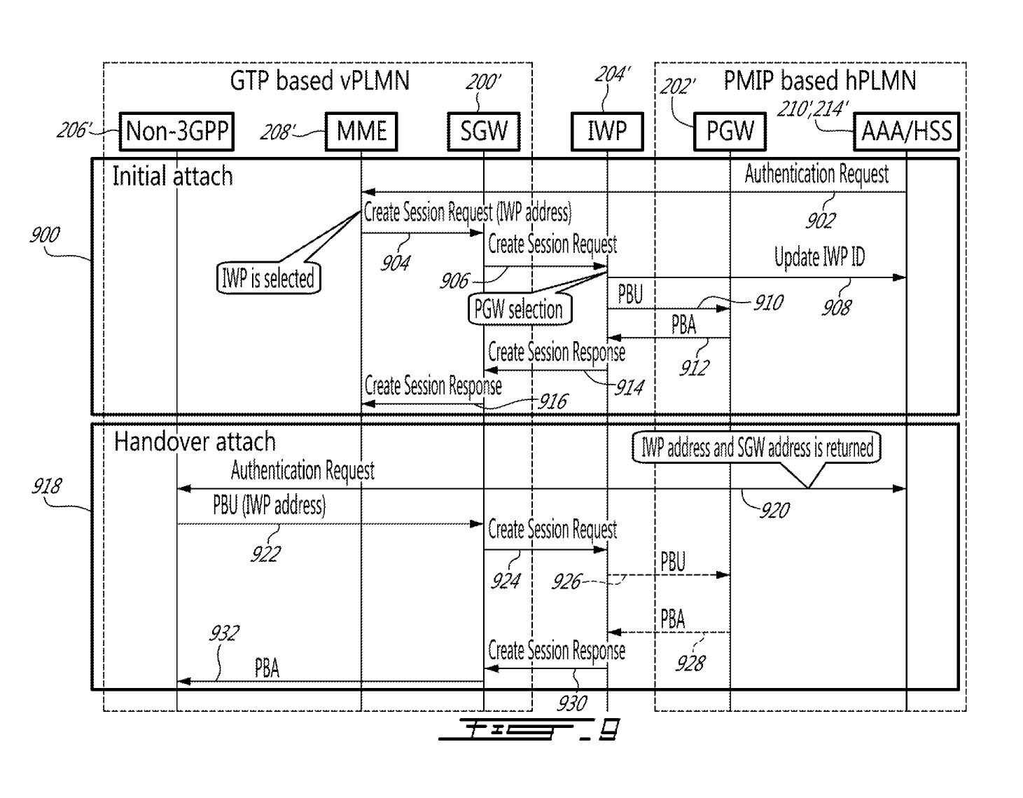

In the first and second embodiments, the first IWP 204′ which is used in the initial attach phase may be the same or different than a second IWP 204′ used in the handover attach phase, since the same IP address for the data connection is ensured by providing the second IWP 204′ with the PGW 202's address which was selected during the initial attach phase. However, in a third embodiment, for both 3GPP access and non-3GPP access cases, a packet data or IP connection associated with a particular UE is preferably routed through the same IWP 204′. This includes both 3GPP traffic and non-3GPP traffic. FIGS. 7 and 8 illustrate interworking architectures which employ this third embodiment, wherein the different PMIP and GTP protocol references indicate that IP connections are routed through the same IWP 204′ regardless of the protocols being used by the interworked systems. Thus, with this architecture, the IWP 204′ becomes the proxy not only for GTP-PMIP traffic but also for PMIP-PMIP traffic. In a vPLMN, the IWP 204′ can always be selected as a PGW 202′ for initial attachment and handover attachment. In an hPLMN, the IWP 204′ can select a new PGW 202′ at initial attachment. At handover attachment, there typically will then be no need to perform a second PGW selection as the IWP 204′ knows which PGW 202′ was connected during the initial attach phase and can, therefore, ensure that the same PGW 202′ is used to continue the handed over data connection without receiving the PGW 202's address via an external signal, thereby also preserving the IP address associated with that connection.

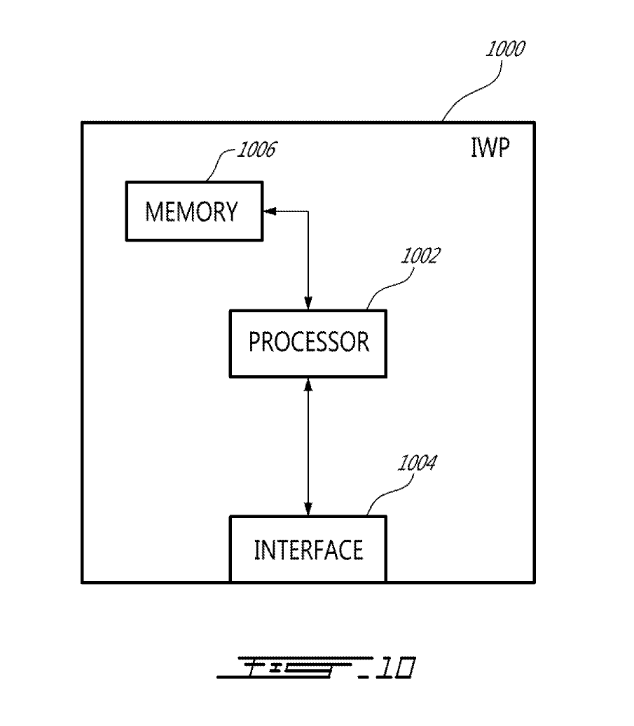

The signaling diagram of FIG. 9 provides an example of how signaling can be performed according to this third embodiment. Therein, during the initial attach phase 900, the 3GPP AAA server 214′ returns the SGW address and IWP address, but not a PGW address, to the MME 208′ via signalling 902. The received SGW address is used by the MME 208′ to generate and send the Create Session Request message 904 toward the SGW 200′. The IWP address information is included in the Create Session Request message 904. The received IWP address is used by the SGW 200′ to generate and send the Create Session Request signal 906 toward IWP 204′.

The IWP 204′, upon receipt of signal 906, sends a signal 908 to update the 3GPP AAA server 214′ with its IWP address. Note that this step/signal differs from the first and second embodiments (as well as the conventional techniques described in the above-identified standards documents) in that the IWP 204′ is performing the updating of the AAA server and/or HSS rather than the PGW 202′ since, in this embodiment, all of the packet data or IP connections are routed through the IWP 204′ regardless of whether there is, or is not, a need for GTP/PMIP interworking. Thus, the 3GPP AAA server 214′ needs to know the address of the IWP 204′ rather than the address of the PGW 202′.

The IWP 204′ performs a PGW selection, and then generates and sends a PBU message 910 to the selected PGW 204′ to establish a PMIP session. The selected PGW 202′ responds with a PBA message 912, in response to which the IWP 204′ sends a Create Session Response message 914 to the SGW 200′. The SGW 200′, in turn, sends a Create Session Response message 916 to the MME 208′.

For handover attach 918, as seen in the lower portion of FIG. 9 in this third embodiment, the 3GPP AAA server 214′ of the home network returns the SGW address and the IWP address to the non-3GPP GW 206′. The received SGW address is used by the non-3GPP GW 206′ for sending the PBU message 922. The IWP address information is included in the PBU message 922. When the SGW 200′ receives the PBU message 922, it generates and sends a Create Session Request message 924 toward the IWP 204′ using the IWP address which it received in the PBU message 922. The IWP 204′ knows which PGW 202′ to re-use for this UE's IP connection, since it selected the PGW 202′ during the initial attach phase and has maintained the PMIP tunnel which was established between the IWP 204′ and PGW 202′ during that initial attach phase. The IWP 204′ may optionally generate and send a PBU message 926 to update the PGW 202′ and, if so, the PGW 202′ can respond with a PBA message 928. With or without the optional updating of the PGW 202′, the handover attach process 918 is then completed by the response/acknowledgement signals 930 and 932 as described above.

From the foregoing, it will be appreciated by those skilled in the art that use of the third embodiment illustrated in FIGS. 7-9, allows for an implementation that avoids impacts on any existing 3GPP interface. In such an embodiment, the IWP 204′ can always be selected by the MME 208′ or by the non-3GPP access GW 206′ as the PGW address. This selection can be achieved, for example, through the use of a DNS query by the MME 208′. At the IWP 204′, a new PGW 202′ can be selected during the initial attachment. If the attachment is a 3GPP attachment, then the MME 208′ can update the HSS 210′ with the selected PGW address, the PGW address in this proxy case being the IWP address. If the initial attachment is a non-3GPP attachment, then IWP 204′ can update the 3GPP AAA server 214′ with its identity over an existing S6b interface. During inter-access handover, the IWP address can be sent to the target access as the PGW address selected by the HSS/AAA 210′, 214′. Upon receipt of the handover attachment request at the IWP 204′, the IWP 204′ can update the UE's binding, and optionally, the PGW 202′ if required.

One skilled in the art will appreciate that the mechanisms outlined above permit the UE session to be established with the current PGW node. This mechanism can be used in both 3GPP and non-3GPP chained cases. The different alternatives provide their functionality with minimal impacts on existing protocols and interfaces, and allow for the reuse of existing 3GPP/non-3GPP attach/detach procedures.

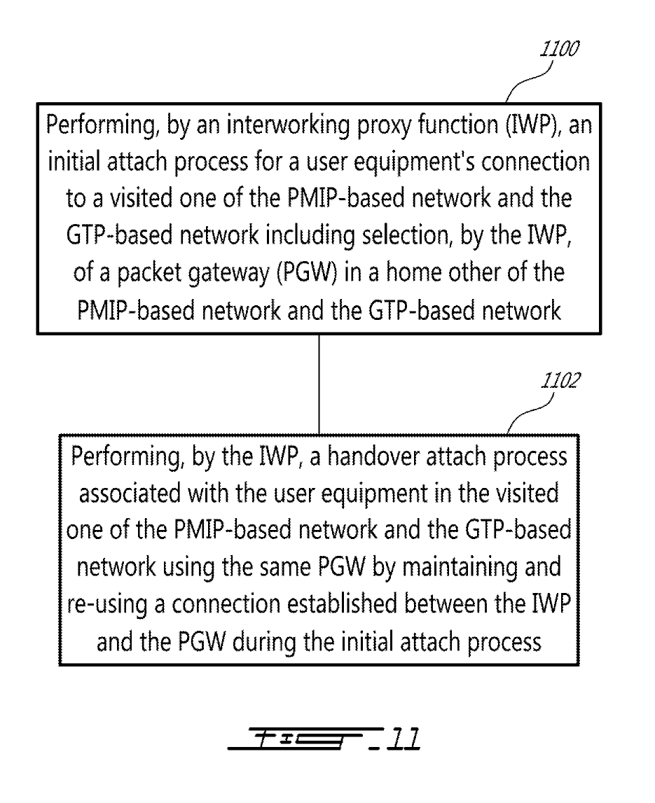

Embodiments described above involve, among other nodes, IWP nodes 204 which can include, for example, the elements illustrated in FIG. 10. Therein, an IWP node 1000 for performing interworking between a PMIP-based network and a GTP-based network, as described above. The IWP node 1000 includes a processor 1002 which, for example, can be configured to perform functions associated with an initial attach process for a user equipment's connection to a visited one of said PMIP-based network and the GTP-based network including selection of a packet gateway (PGW) in a home other of the PMIP-based network and the GTP-based network, and further configured to perform functions associated with a handover attach process for the user equipment in the visited one of the PMIP-based network and the GTP-based network using the same PGW by maintaining and re-using a connection established between the IWP and said PGW during the initial attach process. The IWP node 1000 can also include one or more interfaces 1004 with which to communicate with other nodes, e.g., a PGW 202′ and an SGW 200′. A memory device 1006 can be connected to the processor 1002 for storing data and/or program instructions associated with the afore-described IWP functionality.

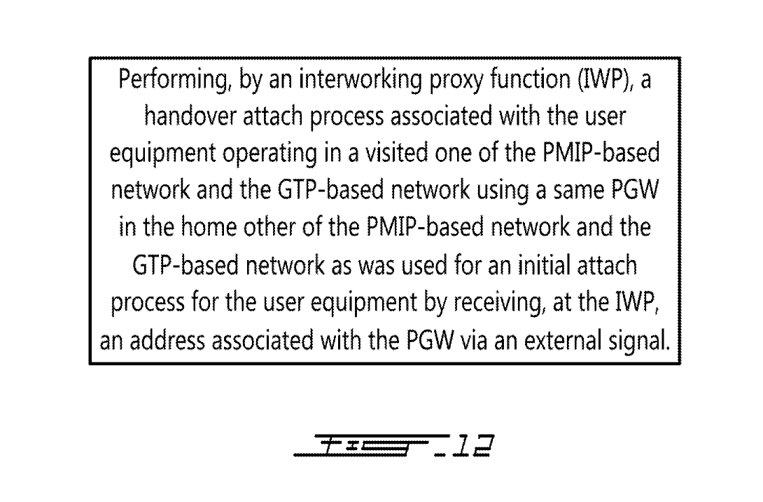

Such functions can include, for example, a method for interworking between a PMIP-based network and a GTP-based network according to an embodiment as shown in the flowchart of FIG. 11. Therein, at step 1100, an initial attach process is performed by an IWP for a user equipment's connection to a visited one of the PMIP-based network and the GTP-based network including selection, by the IWP, of a PGW in a home other of the PMIP-based network and the GTP-based network. At step 1102, a handover attach process associated with the user equipment in the visited one of the PMIP-based network and the GTP-based network is performed by the IWP using the same PGW by maintaining and re-using a connection established between the IWP and the PGW during the initial attach process.

Another method for interworking between a PMIP-based network and a GTP-based network is shown in the flowchart of FIG. 12. Therein, at step 1200, a handover attach process associated with user equipment operating in a visited one of the PMIP-based network and the GTP-based network is performed by an IWP using a same PGW in the home other of the PMIP-based network and the GTP-based network as was used for an initial attach process for the user equipment by receiving, at the IWP, an address associated with the PGW via an external signal.

Embodiments may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

1. A method for interworking between a Proxy Mobile IP (PMIP)-based network and a GPRS Tunneling Protocol (GTP)-based network, the method comprising:
subsequent to the selection of a packet gateway (PGW) by an interworking proxy function (IWP) in a home network associated with a user equipment (UE), and during an initial attach process of the UE to a visited network,
receiving by the PGW, from the IWP, a Proxy Binding Update (PBU) requesting establishment of an IWP-PGW connection;
transmitting from the PGW to an authentication, authorization and accounting (AAA)/Home Subscriber Server (HSS) server an address associated with the IWP and an address associated with the PGW for storage by the AAA/HSS server to allow, during a subsequent attach process associated with the UE, reuse of the IWP-PGW connection established during the initial attach process;
wherein the home network is one of the PMIP based network and the GTP based network, and the visited network is the other of the PMIP based network and the GTP based network.

2. The method claimed in claim 1, wherein the subsequent attach is a handover attach of the UE to the home network.

3. The method claimed in claim 1, wherein one of the home network and the visited network is a non-3GPP access network.

4. The method claimed in claim 1, wherein a data session formed between the IWP and the PGW is maintained and re-used during the subsequent attach to the other network

5. The method of claim 1 wherein one of the address associated with the IWP and the address associated with the PGW is an IP address.

6. A packet gateway (PGW) adapted for:
receiving, during an initial attach process of a user equipment (UE) to a visited network, from an interworking proxy function (IWP) in a home network, a proxy binding update (PBU) requesting establishment of an IWP-PGW connection;
transmitting an address associated with the IWP and an address associated with the PGW to an authentication, authorization and account (AAA)/Home Subscriber Server (HSS) server for storage by the AAA/HSS server to allow, during a subsequent attach process associated with the UE, reuse of the IWP-PGW connection established during the initial attach process; and
wherein the visited network is one of a Proxy Mobile IP (PMIP)-based network and a GPRS Tunnelling Protocol (GTP)-based network and the home network is the other of the PMIP-based network and the GTP-based network.

7. The PGW of claim 6, wherein one of a home network associated with the UE and the visited network is a non-3GPP access network.

8. The PGW of claim 6, wherein the subsequent attach is a handover attach of the UE from the visited network to a home network associated with the UE;

9. The method of claim 6 wherein the home network is one of a PMIP-based network and a GTP-based network, and is not the same network type as the visited network.

10. The method of claim 6 wherein a data session formed between the IWP and the PGW is maintained and re-used during the subsequent attach to the other network.

11. The method of claim 6 wherein one of the address associated with the IWP and the address associated with the PGW is an IP address.

12. A method for interworking between a Proxy Mobile IP (PMIP)-based network and a GPRS Tunneling Protocol (GTP)-based network, the method comprising:
subsequent to the selection of a packet gateway (PGW) by an interworking proxy function (IWP) in a home network associated with a user equipment (UE), and during an initial attach of the UE to a visited network,
receiving by an authentication, authorization and accounting (AAA)/Home Subscriber Server (HSS) server from the selected PGW an address associated with IWP and an address associated with the PGW;
storing by the AAA/HSS server the received address associated with the IWP and the address associated with the PGW;
during a subsequent attach process associated with the UE and a second visited network, sending from the AAA/HSS server to a PGW in the second visited network the address associated with the PGW and the address associated with the IWP received from the selected PGW to permit reuse of a data session between the PGW and IWP associated with the respective addresses;
wherein the home network is one of the PMIP-based network and the GTP-based network and the visited network is the other of the PMIP-based network and the GTP-based network.

13. The method claimed in claim 12, wherein the subsequent attach is a handover attach of the UE to the other network.

14. The method claimed in claim 12, wherein during the subsequent attach of the UE to the second visited network, the AAA/HSS server sends to a gateway of the second visited network the address associated with the IWP during an authentication procedure, and sends the address associated with the PGW to the IPW for facilitating the subsequent attach.

15. A authentication, authorization and accounting (AAA)/Home Subscriber Server (HSS) server adapted for:
receiving during an initial attach of a user equipment (UE) to a visited network, from a Packet Gateway (PGW), an address associated with an Interworking Proxy function (IWP) in a home network associated with the UE, and an address associated with the PGW,
storing the received address associated with the IWP the address associated with the PGW; and
sending, during a subsequent attach of the UE to a second visited network, to a PGW in the second visited network, the received address associated with the IWP and the received address associated with the PGW, to serve in a subsequent selection by the second visited network of the same IWP and the same PGW for establishment of a data session;
wherein the visited network is one of a Proxy Mobile IP (PMIP)-based network and a GPRS Tunneling Protocol (GTP)-based network and the home network is the other of the PMIP-based network and the GTP-based network.

16. The AAA/HSS server claimed in claim 15, wherein the subsequent attach is a handover attach of the UE to the second visited network.

17. The AAA/HSS server claimed in claim 15, the server being further adapted to send, during the subsequent attach of the UE to the second visited network, to a gateway of the second visited network the received address associated with the IWP during an authentication procedure, and to send the received address associated with the PGW to the IPW for facilitating the subsequent attach.

18. A method for interworking between a Proxy Mobile IP (PMIP)-based network and a GPRS Tunneling Protocol (GTP)-based network, the method comprising the steps of:
receiving by an access gateway during an authentication procedure of a network attach, an Inter Working Proxy (IWP) identifier and a Packet Gateway (PGW) identifier; and
sending, from the access gateway to a Serving Gateway (SGW), a Proxy Binding Update (PBU) request for establishing a data session, the PBU request comprising the IWP identifier and the PGW identifier;
whereby the IWP identifier and the PGW identifier facilitate selection by the SGW of the IWP identified by the IWP identifier and of the GW identified by the PGW identifier for establishing a data session.

19. An access gateway adapted to receive during an authentication procedure of a network attach an Inter Working Proxy (IWP) identifier and a Packet Gateway (PGW) identifier, the gateway being further adapted to send a Proxy Binding Update (PBU) request for establishing a data session to a Serving Gateway (SGW), the PBU request comprising the IWP identifier and the PGW identifier, whereby the IWP identifier and the PGW identifier facilitate selection by the SGW of the IWP identified by the IWP identifier.

20. A method for interworking between a Proxy Mobile IP (PMIP)-based network and a GPRS Tunneling Protocol (GTP)-based network, the method comprising the steps of:
receiving by a Serving Gateway (SGW) during an authentication procedure of a network attach, an Inter Working Proxy (IWP) identifier and a Packet Gateway (PGW) identifier; and
sending from the SGW to the IWP identified by the IWP identifier a request for creating a data session, using the IWP identifier received from the SGW, the request for creating the data session comprising the PGW identifier.

21. A Serving Gateway (SGW) adapted to receive during an authentication procedure of a network attach an Inter Working proxy (IWP) identifier and a Packet Gateway (PGW) identifier, the SGW being further adapted to send a request for establishing a data session to the IWP identified by the IWP identifier using the IWP identifier received from the SGW, the request for creating the data session comprising the PGW identifier.

22. A method for interworking between a node Mobile IP (PMIP)-based network and a GPRS Tunneling Protocol (GTP)-based network, the method comprising:
during an initial attach of a user equipment (UE) to a visited one of said PMIP-based network and said GTP-based network,
receiving by an Inter Working Proxy (IWP) a request for creating a data session;
selecting a Packet Gateway (PGW) for creating the data session; and
transmitting from the IWP to an authentication, authorization and accounting (AAA)/Home Subscriber Server (HSS) server an identifier of the IWP;
whereby the IWP identifier is transmitted to be stored by the AAA/HSS server for facilitating subsequent UE attachments.

23. The method claimed in claim 22, further comprising the step of:
during a subsequent attach of the same UE to another network, receiving by the same IWP another request for setting up a data session; and
selecting by the IWP the same PGW for setting up the data session.

24. The method claimed in claim 22, wherein the subsequent attach is a handover attach of the UE to the other network.

25. The method claimed in claim 22, wherein the other network is a non-3GPP access network.

26. The method claimed in claim 22, wherein the same data session is maintained and re-used between the IWP and the PGW during the subsequent attach to the other network.

27. An Inter Working Proxy (IWP) node adapted for receiving, during an initial attach process of a user equipment (UE) to a visited one a PMIP-based network and a GTP-based network, a request for creating a data session and for selecting a Packet Gateway (PGW) for creating the data session, and further for transmitting from the IWP to an authentication, authorization and accounting (AAA)/Home Subscriber Server (HSS) server an identifier of the IWP, whereby the IWP identifier is transmitted to be stored by the AAA/HSS server for facilitating subsequent UE attachments.

28. The IWP node claimed in claim 27, further adapted to receive, during a subsequent attach of the same UE to another network, another request for setting up a data session, and to select the same PGW for setting up the data session.

29. The IWP node claimed in claim 27, wherein the subsequent attach is a handover attach of the UE to the other network.

30. The IWP node claimed in claim 27, wherein the other network is a non-3GPP access network.

31. The IWP node claimed in claim 27, wherein the same data session is maintained and re-used between the IWP and the PGW during the subsequent attach to the other network.

32. A method for interworking between a Proxy Mobile IP (PMIP)-based network and a GPRS Tunneling Protocol (GTP)-based network, the method comprising:
during an initial attach of a user equipment (UE) to a visited one of said PMIP-based network and said GTP-based network, receiving by an authentication, authorization and accounting (AAA)/Home Subscriber Server (HSS) server from an Inter Working Proxy (IWP) an identifier of the IWP;
storing by the AAA/HSS server the IWP identifier;
during a subsequent attach of the UE to another network, sending from the AAA/HSS server to the other network the IWP identifier to serve in selection by the other network of the same IWP for establishment of a data session.

33. The method claimed in claim 32, wherein the subsequent attach is a handover attach of the UE to the other network.

34. The method claimed in claim 32, wherein the other network is a non-3GPP network.

35. The method claimed in claim 32, wherein during the subsequent attach of the UE to the other network, the AAA/HSS server sends to a gateway of the other network the IWP identifier during an authentication procedure for facilitating the subsequent attach.

36. The method claimed in claim 32, wherein the same data session is maintained and re-used between the IWP and the PGW during the subsequent attach to the other network.

37. A authentication, authorization and accounting (AAA)/Home Subscriber Server (HSS) server adapted for receiving during an initial attach of a user equipment (UE) to a visited one of said PMIP-based network and said GTP-based network, from an Inter-Working Proxy (IWP), an identifier of the IWP, the AAA/HSS server being further adapted for storing the IWP identifier and for sending, during a subsequent attach of the UE to another network, the IWP identifier, to serve in a subsequent selection by the other network of the same IWP for establishment of a data session.

38. The AAA/HSS server claimed in claim 37, wherein the subsequent attach is a handover attach of the UE to the other network.

39. The AAA/HSS server claimed in claim 37, wherein the other network is a non-3GPP network.

40. The AAA/HSS server claimed in claim 37, the server being further adapted to send, during the subsequent attach of the UE to the other network, to a gateway of the other network the IWP identifier during an authentication procedure.

41. The AAA/HSS server claimed in claim 37, wherein the same data session is maintained and re-used between the IWP and the PGW during the subsequent attach to the other network.
